(19) United States
(12) Patent Application Publication
(10) Pub. No.: US 2014/0347279 A1
(43) Pub. Date: Nov. 27, 2014

(54) KEYBOARD DEVICE WITH SWITCHABLE CONNECTION PATH AND ITS SWITCHING METHOD

(71) Applicants: INVENTEC CORPORATION, Taipei (TW); Inventec (Pudong) Technology Corporation, Shanghai (CN)

(72) Inventor: Huang-Hsiang CHIANG, Taipei (TW)

(73) Assignees: INVENTEC CORPORATION, Taipei (TW); Inventec (Pudong) Technology Corporation, Shanghai (CN)

(21) Appl. No.: 14/245,267

(22) Filed: Apr. 4, 2014

(30) Foreign Application Priority Data
May 21, 2013 (CN) 201310188731.9

(51) Int. Cl. G06F 3/02

(52) U.S. Cl. CPC G06F 3/0227
USPC 345/168

(57) ABSTRACT

A keyboard device with switchable connection path includes a keyboard, a device controller, a first switch, a second switch and a wireless communication module. The device controller is electrically connected to the keyboard. A wireless communication module is electrically connected to the device controller. The first switch is electrically connected to a system controller and the device controller. The second switch is electrically connected to the keyboard and the wireless communication module. The method of switching connection paths of the keyboard includes: connecting a system controller to a keyboard and a wireless communication module; disconnecting the system controller from the keyboard and the wireless communication module; and connecting the keyboard to the wireless communication module. This disclosure allows one keyboard to be shared between a system device and an external mobile device.

### CROSS-REFERENCE TO RELATED APPLICATIONS

This non-provisional application claims priority under 35 U.S.C. §119(a) on Patent Application No(s). 201310188731.9 filed in China on May 21, 2013, the entire contents of which are hereby incorporated by reference.

### BACKGROUND

1. Technical Field

This disclosure relates to a type of keyboard and its switching method, especially relates to a type of keyboard that has a switchable connection path that can be shared with the sharable keyboard of an external mobile device, and the switching method of such keyboard.

2. Related Art

Laptop computers are characterized with good portability and can be used in the same manner as a desktop computer. For example, keyboards of both laptop computers and desktop computers have almost the same setup and operation method. A keyboard device built-in on a laptop computer communicates with the laptop computer through an Embedded Controller (EC). However, when the laptop computer is shutdown, the input device on the laptop, for example the keyboard, cannot be utilized or operated. On the other hand, the built-in keyboard is limited to use with the laptop computer, hence it is left to idle when the laptop computer is not turned on or not utilized.

Nowadays, the utilization of smart phones and tablet computers are on a rise. Business people often need to enter copious amount of information when using smart phones and tablet computers, but are limited to a simulated keyboard provided by the smart phones or tablet computers. Because of the small area available to display the simulated keyboard, the input of information requires excessive complicated procedures. The simulated keyboard lacks the convenience, touch, and efficiency of a physical keyboard.

### SUMMARY

To provide a solution to the problem mentioned above, the present disclosure allows the utilization of a built-in keyboard of a laptop computer to be switched to a smart phone or a tablet computer. Doing so allows mobile devices to share the utilization of the built-in keyboard of the laptop computer.

The present disclosure provides keyboard device with switchable connection path including a keyboard, a device controller, a first switch, a second switch, and a wireless communication module. The device controller is electrically connected to the keyboard, and is for controlling the data transmission of the keyboard. A wireless communication module is electrically connected to the device controller, and is for communicating wirelessly with an electrical device. The first switch is electrically connected to a system controller and the device controller, and is for controlling the connection status between the system controller and the device controller. The second switch is electrically connected to the keyboard and the wireless communication module, and is for controlling the connection status between the keyboard and the wireless communication module. When the first switch is enabled and the second switch is disabled, the system controller is connected to the keyboard and the wireless communication module. When the first switch is disabled and the second switch is enabled, the keyboard is connected to the wireless communication module.

In one embodiment of the present disclosure, the device controller is a Universal Serial Bus (USB) hub, and the wireless communication module is a Bluetooth communication module.

The present disclosure provides a method for switching keyboard connection paths, including the steps of: connecting a system controller to a keyboard and a wireless communication module; disconnecting the system controller from the keyboard and the wireless communication module; and connecting the keyboard to the wireless communication module.

In one embodiment of the present disclosure, the above mentioned step of connecting the system controller to the keyboard and the wireless communication module first includes determining whether the system controller is in an operating state. When the system controller is in the operating state, the following steps are performed: disabling a second switch; enabling a first switch; and connecting the system controller to the keyboard and the wireless communication module. When the system controller is not in the operating state, the system controller is disconnected from the keyboard and the wireless communication module.

In one embodiment of the present disclosure, the above mentioned step of connecting the keyboard to the wireless communication module includes the steps of disabling the first switch; enabling the second switch; and connecting the keyboard to the wireless communication module.

In one embodiment of the present disclosure, after the above mentioned step of connecting the keyboard to the wireless communication module, the method for switching keyboard connection paths further includes first determining whether to switch the wireless communication module to be connected to the electrical device. Then when the wireless communication module is determined to be connected to the electrical device, the system controller is disconnected from the keyboard and the wireless communication module. And when the wireless communication module is determined to not be connected to the electrical device, the method returns to the previous step of determining whether to switch the wireless communication module to be connected to the electrical device.

In one embodiment of the present disclosure, after the above mentioned step of connecting the keyboard to the wireless communication module, the method for switching keyboard connection paths further includes first determining whether to switch the keyboard and the wireless communication module to be coupled to the system controller. Then, when the keyboard and the wireless communication module is determined to be coupled to the system controller, the next step is connecting the system controller to the keyboard and the wireless communication module. On the other hand, when the keyboard and the wireless communication module is determined to not be coupled to the system controller, the next step becomes determining whether to switch the keyboard and the wireless communication module to be coupled to the system controller.

In summary, this disclosure provides a keyboard device with switchable connection path, and its switching method. The switching method connects a system controller to a keyboard and a wireless communication module, and then determines whether to switch the wireless communication module to be connected to the electrical device. When the wireless communication module is determined to be connected to the electrical device, the switching method then disconnects the system controller from the keyboard and the wireless communication module, and connects the keyboard to the wireless communication module. Therefore, the keyboard device with switchable connection path and its switching method of the present disclosure can be switched to different connection paths, to allow one keyboard to be shared between a system device and an external mobile device.

### BRIEF DESCRIPTION OF THE DRAWINGS

The present disclosure will become more fully understood from the detailed description given herein below for illustration only, and thus does not limit the present disclosure, wherein:

FIG. 1 is a system block diagram of a system structure with a keyboard device according to an embodiment of the present disclosure.

FIG. 2 is a flowchart of an operating method of a keyboard device according to an embodiment of the present disclosure.

FIG. 3 is a flowchart of the step S210 of an operating method of a keyboard device according to an embodiment of the present disclosure.

FIG. 4 is a flowchart of the step S230 of an operating method of a keyboard device according to an embodiment of the present disclosure.

FIG. 5 is a flowchart of another operating method of a keyboard device according to an embodiment of the present disclosure.

FIG. 6 is a flowchart of yet another operating method of a keyboard device according to an embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

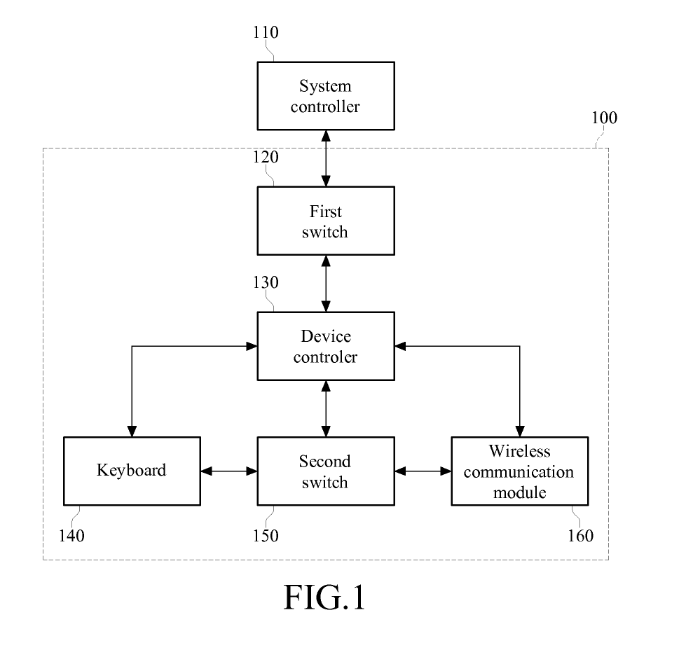

Please refer to FIG. 1, which is a system block diagram of a system structure with a keyboard device according to an embodiment of the present disclosure. A keyboard device 100 with switchable connection path of the present disclosure includes a first switch 120, a device controller 130, a keyboard 140, a second switch 150, and a wireless communication module 160. The device controller 130 is electrically connected to the keyboard 140, and is for controlling the data transmission of the keyboard 140. A wireless communication module 160 is electrically connected to the device controller 130, and is for communicating wirelessly with an electrical device (no shown in Figure). The first switch 120 is electrically connected to a system controller 110 and the device controller 130, and is for controlling the connection status between the system controller 110 and the device controller 130. The second switch 150 is electrically connected to the keyboard 140 and the wireless communication module 160, and is for controlling the connection status between the keyboard 140 and the wireless communication module 160.

When the first switch 120 is enabled and the second switch 150 is disabled, the system controller 110 is connected to the keyboard 140 and the wireless communication module 160. When the first switch 120 is disabled and the second switch 150 is enabled, the keyboard 140 is connected to the wireless communication module 160.

In this embodiment, the system controller 110 can be, but is not limited to, an input-output port (I/O port) of a laptop computer, and the device controller 130 is a universal serial bus hub (USB hub) or a set-up chip of this USB hub. The first switch 120 and the second switch 150 can be, but are not limited to, button type switches, touch sensing type switches, or signal controlled switches. Wireless communication module 160 is, for example, a Bluetooth module or a WiFi module, but is not limited to these.

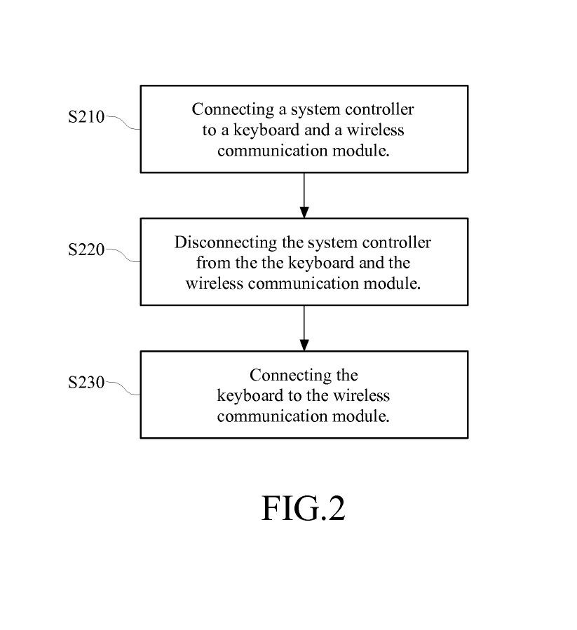

Please refer to FIG. 2, which is a flowchart of an operating method of a keyboard device according to an embodiment of the present disclosure. In this embodiment, a process controller (not shown in Figure) controls the actions of the first switch 120 and the second switch 150. The process controller can control the connecting process of the keyboard 140, the system controller 110, and the wireless communication module 160. The process controller can be a control unit within the system controller 110, a control unit within the device controller 130, or any other controller chosen by the user, but is not limited to these. The present disclosure provides a method for switching keyboard 140 connection paths, including the steps of: (step S210) connecting a system controller 110 to a keyboard 140 and a wireless communication module 160; (step S220) disconnecting the system controller 110 from the keyboard 140 and the wireless communication module 160; and (step S230) connecting the keyboard 140 to the wireless communication module 160.

For clearer explanation, the following explanation will use a laptop computer (not shown in Figure) in combination with a keyboard device 100 with switchable connection path according to an embodiment of the present disclosure. First, (step S210) the laptop computer (the process controller mentioned above within) connects the system controller 110 to the keyboard 140 and the wireless communication module 160. At this point, the keyboard 140 and the wireless communication module 160 operate independently. In other words, the keyboard 140 functions in the laptop computer as a keyboard inputting function, and the wireless communication module 160 functions in the laptop computer as a wireless connection function. In this embodiment, the system controller 110 is the south bridge of the laptop computer, and controls the connection of the computer to the external devices, but the disclosure is not limited by this.

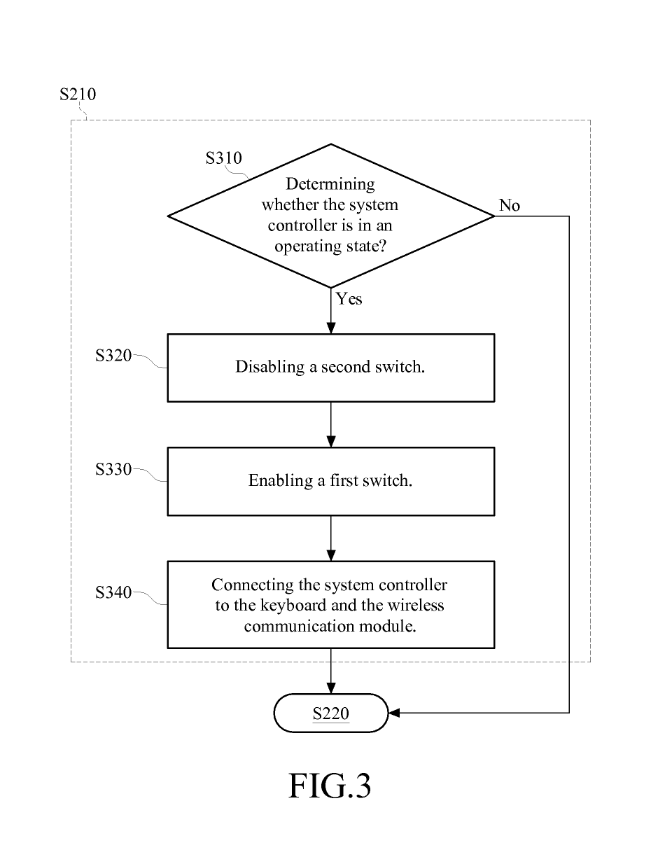

Please refer to FIG. 3, which is a flowchart of the step S210 of an operating method of a keyboard device 100 according to an embodiment of the present disclosure. The step S210 first includes step S310, determining whether the system controller 110 is in an operating state. When the system controller 110 is in the operating state, the process controller performs the following steps: (Step S320) disabling a second switch 150; (Step S330) enabling a first switch 120; and (Step 340) connecting the system controller 110 to the keyboard 140 and the wireless communication module 160. At this point, signals to and from the keyboard 140 and the wireless communication module 160 are transmitted and received by the device controller 130 respectively. The signals are communicated to the system controller 110 through the first switch 120. The device controller 130 here is a USB connector or USB control chip. And the system controller 110 here is a south bridge of the laptop computer.

When the system controller 110 is not in the operating state, the system controller 110 is disconnected from the keyboard 140 and the wireless communication module 160. In other words, in this embodiment, when the laptop computer is operating, the keyboard 140 functions in the laptop computer as a keyboard inputting function, and the wireless communication module 160 functions in the laptop computer as a wireless connection function. This is the familiar operating state of common laptop computers.

When the user switches to share the keyboard device 100 with an electrical device, the process controller first performs step S220, disconnecting the system controller 110 from the keyboard 140 and the wireless communication module 160. The process controller then disables the first switch 120, this interrupts the connection from the laptop computer to the keyboard 140 and the wireless communication module 160. Then the system controller 110 connects the keyboard 140 to the wireless communication module 160 (step S230).

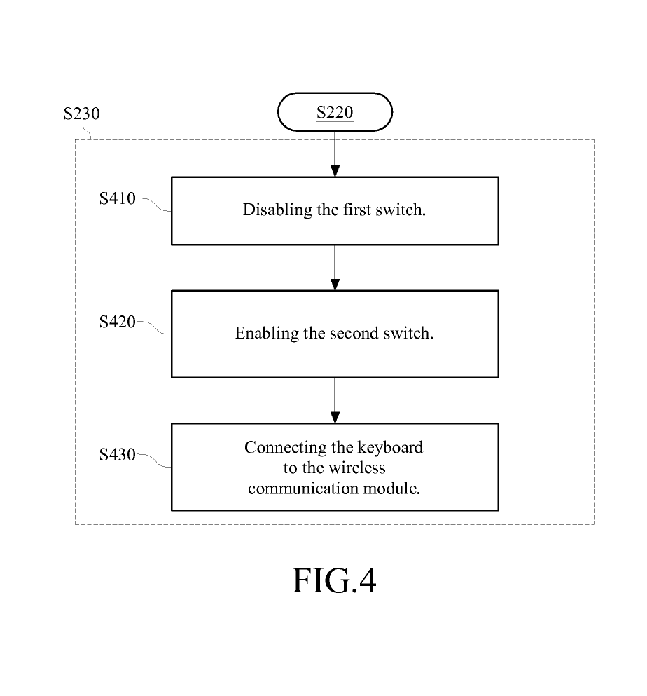

Please refer to FIG. 4, which is a flowchart of the step S230 of an operating method of a keyboard device 100 according to an embodiment of the present disclosure. First, the process controller disables the first switch 120, step S410. Then the process controller enables the second switch 150 (step S420), and then connects the keyboard 140 to the wireless communication module 160 (step S430). At this point, the signals between the keyboard 140 and the wireless communication module 160 are connected. In this embodiment, the wireless communication module 160 is, for example, a Bluetooth communication module. In other words, the keyboard 140 and the wireless communication module 160 here becomes a wireless Bluetooth keyboard. And when the electronic device (not shown in Figure) connects to the Bluetooth keyboard, the process controller connects the wireless communication module 160 (Bluetooth communication module) to the wireless mobile device. Here the wireless Bluetooth keyboard functions as an inputting keyboard function for the wireless mobile device.

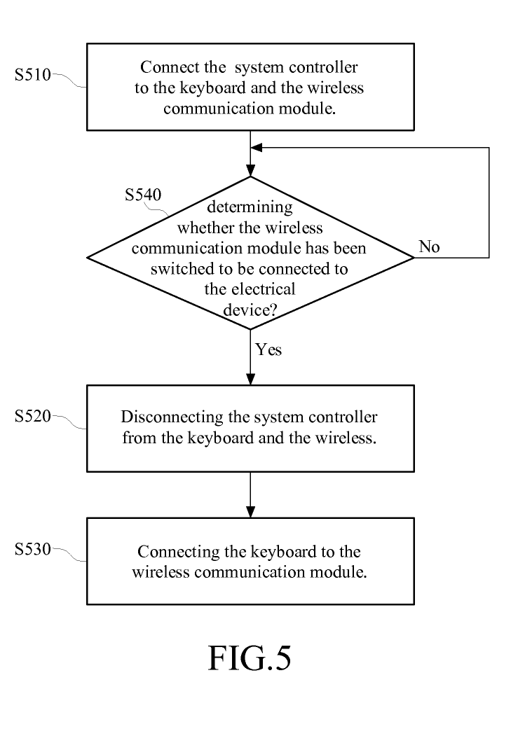

Please refer to FIG. 5, which is a flowchart of another operating method of a keyboard device 100 according to an embodiment of the present disclosure. The difference between in FIG. 5 and FIG. 2 lies in the extra steps present in the method in FIG. 5 after the step S210 (which is S510 in FIG. 5) of connecting the keyboard 140 to the wireless communication module 160. The extra steps include (step S540) determining whether to switch the wireless communication module 160 to be connected to the electrical device. Then when the wireless communication module 160 is determined to be connected to the electrical device, (step S530) the system controller 110 is disconnected from the keyboard 140 and the wireless communication module 160. And when the wireless communication module 160 is determined to not be connected to the electrical device, the process controller returns to the previous step (S510) of determining whether to switch the wireless communication module 160 to be connected to the electrical device.

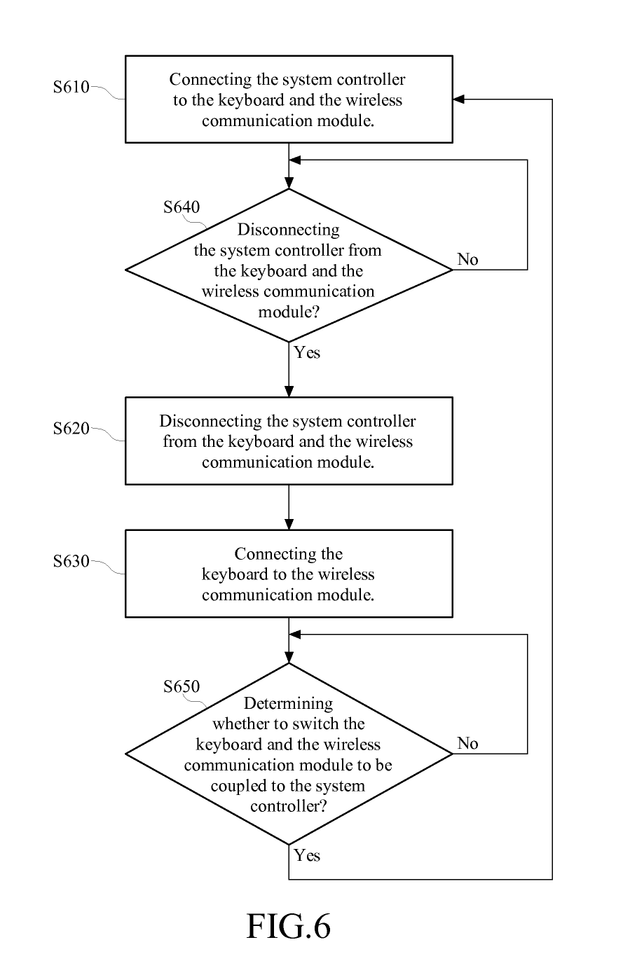

Please refer to FIG. 6, which is a flowchart of yet another operating method of a keyboard device 100 according to an embodiment of the present disclosure. When the user switches the keyboard 140 back to be connected to the laptop computer, meaning the user intends to interrupt the connection from the electrical device to the keyboard 140 and the wireless communication module 160, the process controller (step S640) disconnects the system controller 110 from the keyboard 140 and the wireless communication module 160, then connects the keyboard 140 to the wireless communication module 160 (step S630). The process controller then determines whether to switch the keyboard 140 and the wireless communication module 160 to be coupled to the system controller 110 (step S650).

Then, when the keyboard 140 and the wireless communication module 160 is determined to be coupled to the system controller 110, the next step is (step S610) connecting the system controller 110 to the keyboard 140 and the wireless communication module 160. On the other hand, when the keyboard 140 and the wireless communication module 160 is determined to not be coupled to the system controller 110, the next step is (step S650) determining whether to switch the keyboard 140 and the wireless communication module 160 to be coupled to the system controller 110.

In summary, this disclosure provides a keyboard device with switchable connection path, and its switching method. The keyboard device with switchable connection path and can follow the switching method of the present disclosure, and be switched to different connection paths to allow one keyboard to be shared between a system device and an external mobile device.

What is claimed is:

1. A keyboard device with switchable connection path, comprising:
a keyboard;
a device controller, electrically connected to the keyboard, for controlling the data transmission of the keyboard;
a wireless communication module, electrically connected to the device controller, for communicating wirelessly with an electrical device;
a first switch, electrically connected between a system controller and the device controller, for controlling the connection status between the system controller and the device controller; and
a second switch, electrically connected between the keyboard and the wireless communication module, for controlling the connection status between the keyboard and the wireless communication module;
wherein when the first switch is enabled and the second switch is disabled, the system controller is connected to the keyboard and the wireless communication module, and when the first switch is disabled and the second switch is enabled, the keyboard is connected to the wireless communication module.

2. The keyboard device with switchable connection path according to claim 1, wherein the device controller is a Universal Serial Bus (USB) hub.

3. The keyboard device with switchable connection path according to claim 1, wherein the wireless communication module is a Bluetooth communication module.

4. A method for switching keyboard connection paths, comprising:
connecting a system controller to a keyboard and a wireless communication module;
disconnecting the system controller from the keyboard and the wireless communication module; and
connecting the keyboard to the wireless communication module.

5. The method for switching keyboard connection paths according to claim 4, wherein the step of connecting the system controller to the keyboard and the wireless communication module comprises:
determining whether the system controller is in an operating state;
when the system controller is in the operating state, performing the following steps:
disabling a second switch;
enabling a first switch; and
connecting the system controller to the keyboard and the wireless communication module; and
when the system controller is not in the operating state, disconnecting the system controller from the keyboard and the wireless communication module.

6. The method for switching keyboard connection paths according to claim 5, wherein the step of connecting the keyboard to the wireless communication module comprises:
disabling the first switch;
enabling the second switch; and
connecting the keyboard to the wireless communication module.

7. The method for switching keyboard connection paths according to claim 6, wherein after the step of connecting the keyboard to the wireless communication module further comprises:
determining whether to switch the wireless communication module to be connected to the electrical device;
when the wireless communication module is determined to be connected to the electrical device, disconnecting the system controller from the keyboard and the wireless communication module; and
when the wireless communication module is determined to not be connected to the electrical device, determining whether to switch the wireless communication module to be connected to the electrical device.

8. The method for switching keyboard connection paths according to claim 4, wherein after the step of connecting the keyboard to the wireless communication module, the method further comprises:
determining whether to switch the keyboard and the wireless communication module to be coupled to the system controller;
when the keyboard and the wireless communication module is determined to be coupled to the system controller, connecting the system controller to the keyboard and the wireless communication module; and
when the keyboard and the wireless communication module is determined to not be coupled to the system controller, determining whether to switch the keyboard and the wireless communication module to be coupled to the system controller.
